(19) United States
(12) Patent Application Publication
(10) Pub. No.: US 2009/0204454 A1
(43) Pub. Date: Aug. 13, 2009

(54) ONLINE HOSTED CUSTOMISABLE MERCHANT DIRECTORY WITH SEARCH FUNCTION

(76) Inventor: Frankie James Lagudi, New South Wales (AU)

Correspondence Address: KNOBBE MARTENS OLSON & BEAR LLP, 2040 MAIN STREET, FOURTEENTH FLOOR, IRVINE, CA, 92614, US

(21) Appl. No.: 12/091,156

(22) PCT Filed: Aug. 27, 2007
(86) PCT No.: PCT/AU07/01230

§ 371 Date: Mar. 24, 2009

(30) Foreign Application Priority Data
Aug. 28, 2006 (AU) 2006904677

(51) Int. Cl. G06Q 30/00; G06F 17/30; G06Q 10/00

(52) U.S. Cl. 705/7; 707/5; 705/27; 707/E17.108; 707/E17.018

(57) ABSTRACT

A method (400) and system (100) are described for providing an online hosted customisable searchable merchant directory over the Internet (101). The system (100) includes an Internet server (102) which provides storefront web page templates (1200). Merchants access the Internet server (102), though merchant computers (105ₙ), to set up one or more storefront web pages associated with a business of each merchant and using said web page templates (1200). The storefront web pages are hosted on the Internet server (102). The system (100) provides the customer a search means (1300) to search for merchants and products within a predefined geographic proximity of the customer.

### FIELD OF THE INVENTION

The present invention relates generally to retail websites and, in particular, to an online hosted customisable searchable merchant directory.

### BACKGROUND

The emergence of the global computer network, or Internet, has dramatically lowered information barriers. Entirely new paradigms for conducting business have evolved or emerged from traditional non-electronic business models. Indeed, the advent of the information age is widely credited with introducing tremendous efficiencies into commercial transactions.

The Internet also has dramatically altered the vendor/customer relationship. Prior to the advent of the Internet, customers faced obstacles when seeking products or services. Research was time-consuming, and everyone from producer to retailer closely guarded information. Now, search engines and other information aggregators offer a wealth of salient product and service information at little or no cost.

Websites have become increasingly popular as businesses recognise the need to maintain a website to be commercially viable. These websites typically are used to advertise the products and services and their prices offered by the businesses and to advertise the business itself.

An obstacle small businesses face is that their business website may be regarded as insignificant by search engines and therefore given a low ranking in search results. Customers would then find it hard to locate the business's website. U.S. Pat. No. 5,946,665 (Suzuki et al., published Aug. 31, 1999) discloses a link aggregator search server system whereby customers can search stores and/or malls for products and services.

However, the cost of building and maintaining a website can be prohibitive to some businesses. The majority of businesses lack the in-house technical ability to create and maintain a website. Others are constrained by the financial burdens of creating and maintaining a website. A known approach to this problem, that has been available since about February 2002, is practiced by eBay™ (http://stores.ebay.com/) that allows users to set up store web pages without having to create and maintain a website.

An obstacle faced by customers is the ability to locate products and services of such businesses in a cost effective manner. At times of low supply and/or high demand, customers face price hikes. The supply and demand problem is especially compounded in the supply of perishable goods such as foodstuffs. Foodstuffs typically have a very short shelf life are therefore more prone to supply shortages.

Thus, a need exists to overcome or at least reduce one or more of these problems.

### SUMMARY

Disclosed is a method of operating an online hosted customisable searchable merchant directory which comprises, providing storefront web page templates hosted on an Internet server, receiving hosting requests from merchants, each request including an indication of the geographical location of the merchant, providing access to the web page templates for merchants to modify their web page templates, receiving a search query from a customer that includes the customer's geographical location and returning only the storefront results for the merchants matching the search query and who have a geographical location within a predetermined distance the customer's location.

Also disclosed is an Internet server for the operation of an online hosted customisable searchable merchant directory comprising a data store to store storefront web page templates, a communication interface for receiving a hosting request from a merchant that includes including the geographical location of the merchant, providing access to the web page templates for the merchants to modify their web page templates, receiving a search query from a customer that includes the geographical location of said customer and a processor for calculating the storefront results for merchants matching the search query and having a geographical location within a predetermined distance of the customer's location and a communication interface for returning the storefront results.

Also disclosed is system for operating a merchant directory containing at least one merchant computer, at least one customer computer and an Internet server. The Internet server includes a data store to store storefront web page templates, a communication interface for receiving a hosting request from a merchant computer, which includes a geographical location of the merchant, providing access to the web page templates for merchants to modify their web page templates, receiving a search query from a customer computer that includes the geographical location of the customer and a processor for calculating the storefront results for the merchants matching the search query and who have a geographical location within a predetermined distance of the customer's location and a communication interface to return the storefront results.

Other aspects are also disclosed.

### BRIEF DESCRIPTION OF THE DRAWINGS

One or more embodiments of the present invention will now be described with reference to the drawings, in which:

FIG. 1 shows a schematic block diagram of a system for providing an online hosted customisable searchable merchant directory;

FIG. 2 shows a schematic block diagram of the Internet server components;

FIG. 3 shows the general page template;

FIG. 4 shows a block flow diagram of a method of providing an online hosted customisable searchable merchant directory;

FIG. 5 shows a block flow diagram of a method for the creation of a merchant storefront;

FIG. 6 shows a form used to input store details;

FIG. 7 shows a form used to select a storefront template;

FIG. 8 shows a form used to customise storefront templates;

FIG. 9 shows a form used to customise storefront images;

FIG. 10 shows a form used to add specials to the storefront;

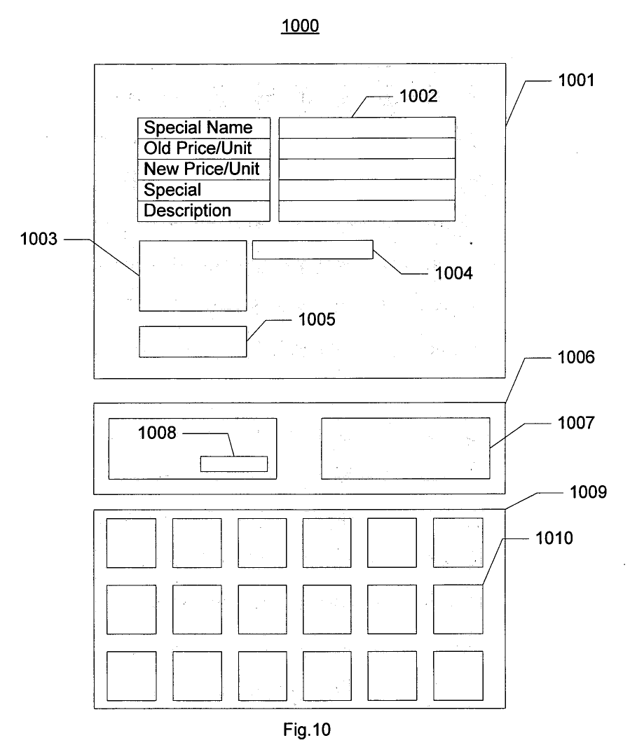

FIG. 11 shows a form used to add vouchers/coupons to the storefront;

FIG. 12 shows a typical storefront layout;

FIG. 13 shows a block flow diagram of a method for searching for a storefront; and

FIG. 14 shows a virtual shopping mall.

### DETAILED DESCRIPTION

### Overview

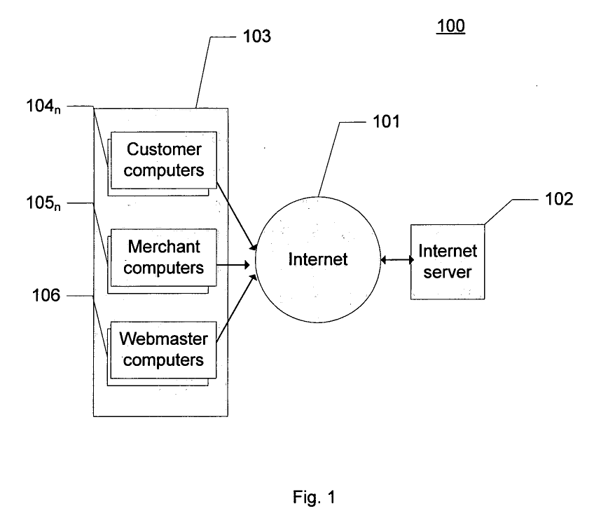

FIG. 1 shows a schematic block diagram of a system 100 for establishing an online hosted customisable searchable merchant directory. The system 100 includes an Internet server 102 which is typically maintained by a service provider. The Internet server 102 is connected to the Internet 101. Web pages served by the Internet server 102 are accessible by clients, who are customers, merchants or webmasters, using their respective client computer stations 104ₙ, 105ₙ and 106 through the Internet 101. More particularly, each client computer 103 is equipped with an Internet browser application, which allows the clients 103 to download web pages from the Internet server 102 and to display such pages on the display of the client computer 104-106 in a manner known in the art.

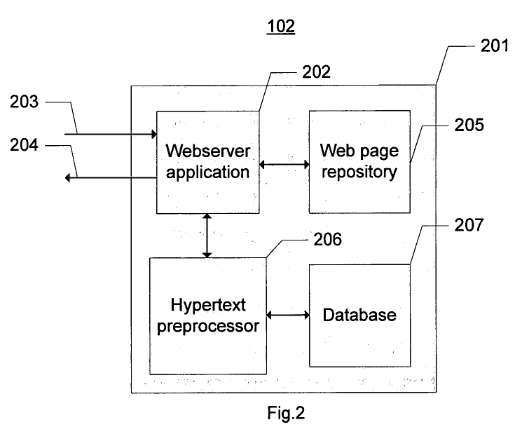

FIG. 2 shows the components of the Internet server 102 applicable to the directory system 100. A webserver application 202 serves HTML (Hypertext Markup Language) code as a response 204 to HTTP (Hyper Text Transfer Protocol) requests 203 from the client computer stations 103. It is preferable that an Apache™ webserver is used. The webserver 202 serves HTML pages from the collection of web pages files in the web page repository 205. The collection of web page files, when served by the webserver application 202 constitute ‘the website’.

A hypertext preprocessor 206 works in conjunction with the webserver application 202 to provide dynamic content. It is preferable that the PHP hypertext preprocessor is used. A database 207 is used as one of the sources of the dynamic content for the hypertext preprocessor 206. It is preferable that the database is a MySql™ database.

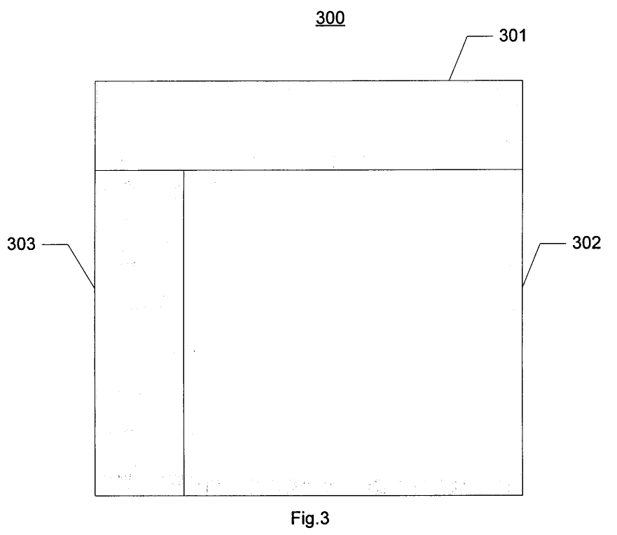

The web page files served by the webserver application 202 are typically are of the layout shown in FIG. 3. The general layout 300, includes a page header section 301, a main content section 302 and a side content section 303. It is preferable that PHP web pages files are used.

Web pages of the website containing information primarily related to a particular merchant are otherwise known as ‘storefronts’ or ‘merchant websites’.

In the Internet server 102, the database 207 and/or web page repository 205 contains data that defines a set of storefront templates.

### Merchant Registration and Storefront Customisation

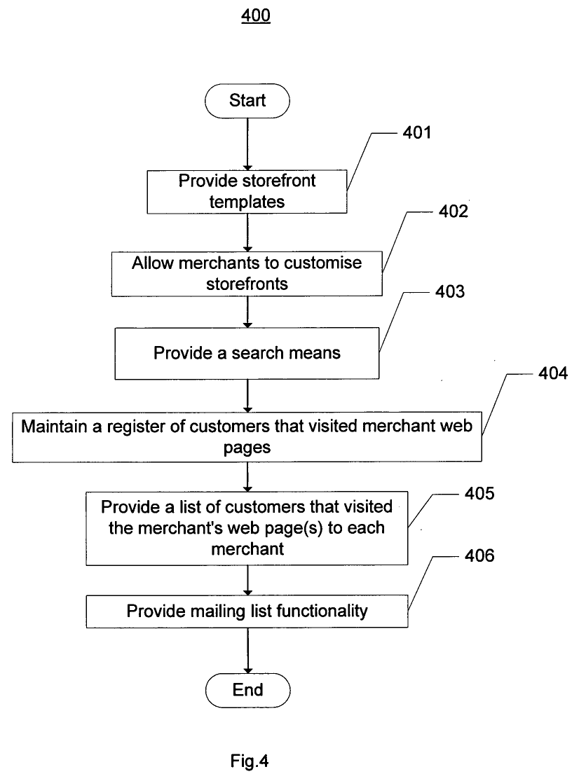

FIG. 4 shows a method 400 of providing an online hosted customisable searchable merchant directory, according to one embodiment. In step 401, a number of storefront templates are provided on the Internet server 102. The method 400 then continues to step 402 where the Internet server 102 allows access to each merchant computer 105 so that the storefront template can be customised. The merchants may customise their storefront at regular intervals, as required. In step 403, the website of the Internet server 102 provides a search means of the merchants and products 105, registered on the Internet server 102.

In a preferred implementation, a register is maintained in step 404, by the Internet server 102 of the merchant storefronts visited by registered customers. Each merchant is provided, in step 405, with a list of registered customers that visited its web page(s). At step 406 merchants are able to contact the customers using the website, typically through sending an electronic mail message, to inform those customers of special prices for goods or services. Alternatively, registered customers may subscribe to merchant mailing lists.

In another implementation, the storefront templates also include templates specifically directed to the restaurant industry. Such templates would provide a facility whereby customers make bookings (e.g. a reservation at a restaurant) through the web page of the merchant. Bookings are confirmed by sending an e-mail message to the customer.

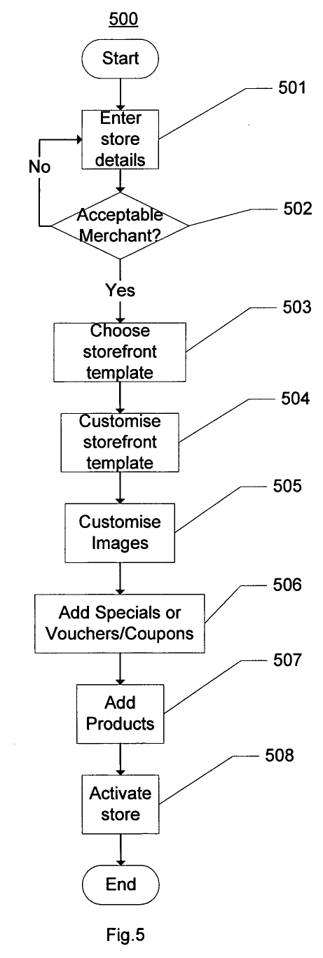

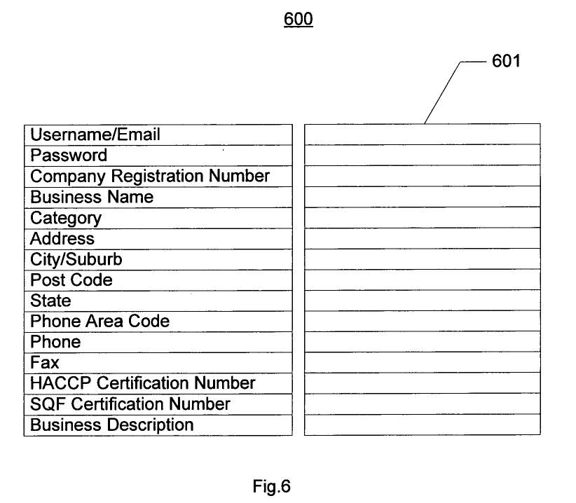

FIG. 5 shows a method 500 of the creating of a merchant storefront on the website. At step 501 of the method 500, a merchant's business details are entered by the merchant. A form used to input the business details 600, shown in FIG. 6, is contained in the main content section 302. The merchant 105ₙ enters the store details into the details input fields 601. When the form is submitted to the Internet server 102 at step 502, the input data will be validated against known number formats and/or business number databases to ensure that it represents an acceptable merchant. An ‘acceptable merchant’ includes a merchant who satisfies one or more criterion of:

a) has provided all of the required information requested by the website,
b) is a registered business and is in possession of a company registration number (tested by checking the syntax of the business registration number and/or validating the business registration number using an available company register or credit agency), or
c) adheres to the applicable food safety health regulations such as the HACCP (Hazard Analysis and Critical Control Point) regulations or the SQF (Safe Quality Food) management programme (tested by checking the syntax of the certification numbers and/or validating the certification numbers using an available certification register). In doing so, customers will be safe in the knowledge that products and services garnered from the merchants on the website will be of high quality and safety.

Additionally, when the form is submitted to the Internet server 102 at step 502, data representing the merchant's geographical location is stored in the database 207. The merchant's geographical location is represented by the postal code or suburb and/or the IP address of the merchant client machine 105ₙ.

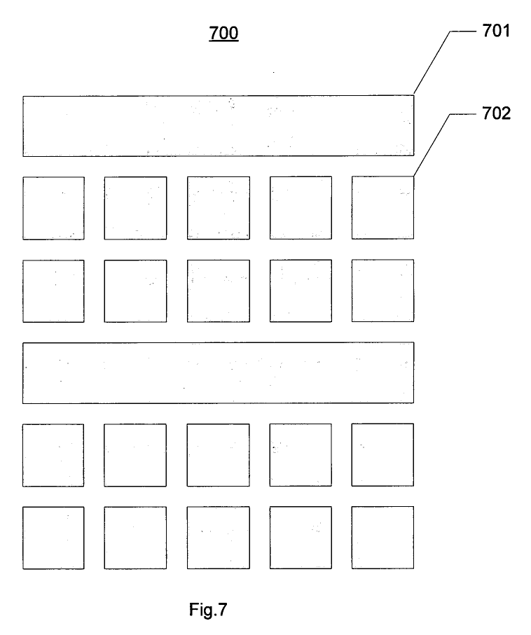

At the next step 503, the merchant chooses a storefront from a plurality of storefront templates. A form used to choose a store template 700, shown in FIG. 7, is contained in the main content section 302 and allows the merchant to choose a storefront template 702 from a plurality of storefront templates from a template section 701.

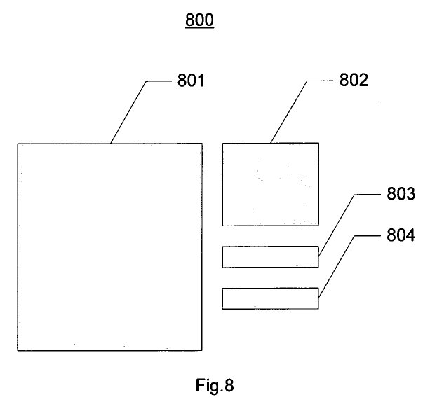

At step 504, the merchant is able to customise the colour and fonts of the chosen storefront. A form used to customise a storefront template 800, shown in FIG. 8, is contained in the main content section 302, and allows the merchant the ability to change the colour of the storefront template using the colour picker palette 802, change the font style using the font style selector 803, change the colour of the font using the font colour selector 804 and view a preview of the storefront in the storefront preview 801.

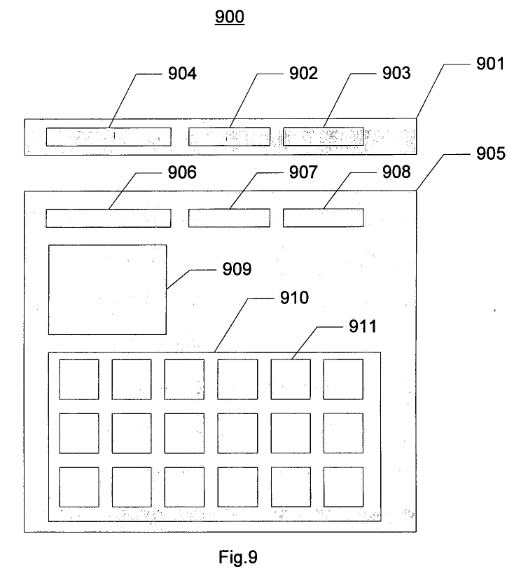

Now, at the step 505 of method 500, the merchant is able to customise the images contained in the chosen storefront. A form used to customise storefront images 900 of FIG. 9 is contained in the main content section 302 and allows the merchant the ability to change the storefront images. The merchant, in the logo image section 901 of FIG. 9, is able to customise the storefront logo using the file browser button 902, file path textbox 904 and upload button 903. The merchant, in the customise main image section 905 of FIG. 9, is able to customise the main image of the storefront using the file browser button 907, file path textbox 906 and upload button 908. Alternatively, the merchant is able to select a sample main image 911 from a plurality of sample main images in the sample images section 910. A preview of the main storefront image is show in the image preview section 909.

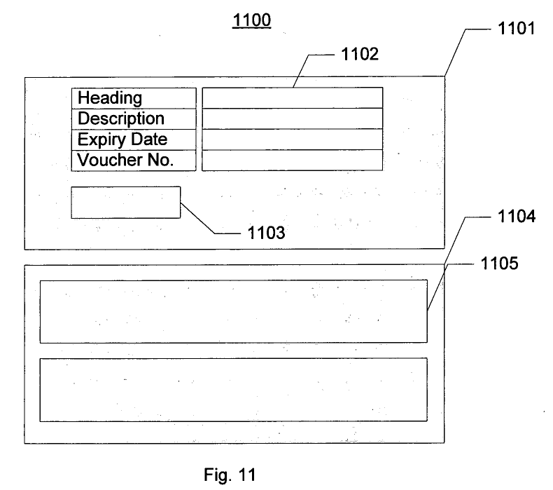

Next, at step 506, the merchant is able to add a plurality of store specials or vouchers/coupons. The specials are added using the add specials form 1000 of FIG. 11. In the edit store special section 1001, the merchant enters the special data into the input fields 1002. The merchant has the ability to edit the image associated with the special using the upload button 1004 or by selecting a sample image 1010 from a plurality of sample images in the sample image section 1009 and to view a preview of the special image in the special image preview section 1003. When the merchant selects the add button 1005, the special is added to the collection of store specials. The collection of store specials 1007 is contained in the store special preview section 1006. Each special has an edit and delete button 1008 allowing the merchant the ability to edit or delete the special. The vouchers/coupons are added using the add vouchers/coupons form 1100. In the voucher detail section 1101, the merchant enters the voucher details using the input fields 1102. The voucher 1105 is added to the voucher collection 1104 when the merchant selects the create voucher button 1103. At step 507 of method 500, the merchant is able to add a plurality of store products.

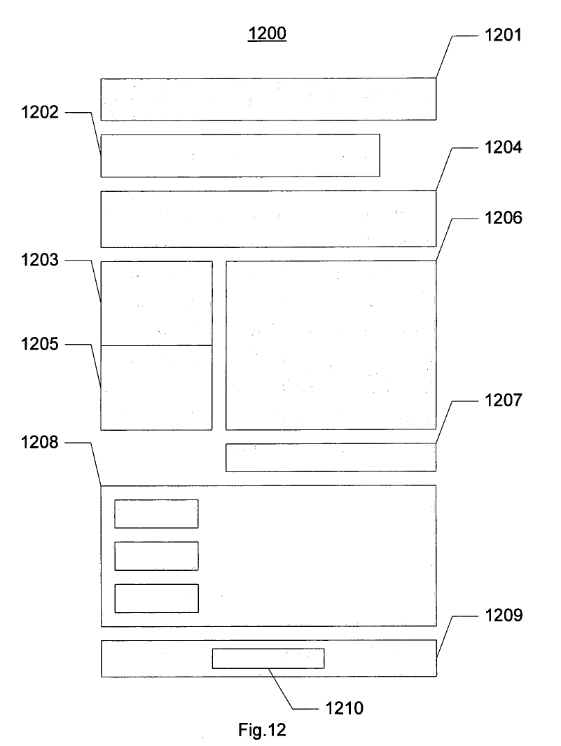

At the final step 508 of method 500, the storefront is activated and becomes visible on the website. The storefront will generally have the components of the typical store layout 1200 shown in FIG. 12. The typical store layout 1200, contains the store category 1201, the store name 1202, e-mail, locate and subscribe user options 1204, the store logo 1203, store address 1205, store image 1206, store description 1207, store specials 1208 and footer 1209 containing a link to the store vouchers/coupons 1210.

Repeating the steps of method 500 as described above, the merchant is able to create a plurality of storefronts pertaining to different geographical locations by specifying the postal/zip codes of said locations.

### Customer Searching

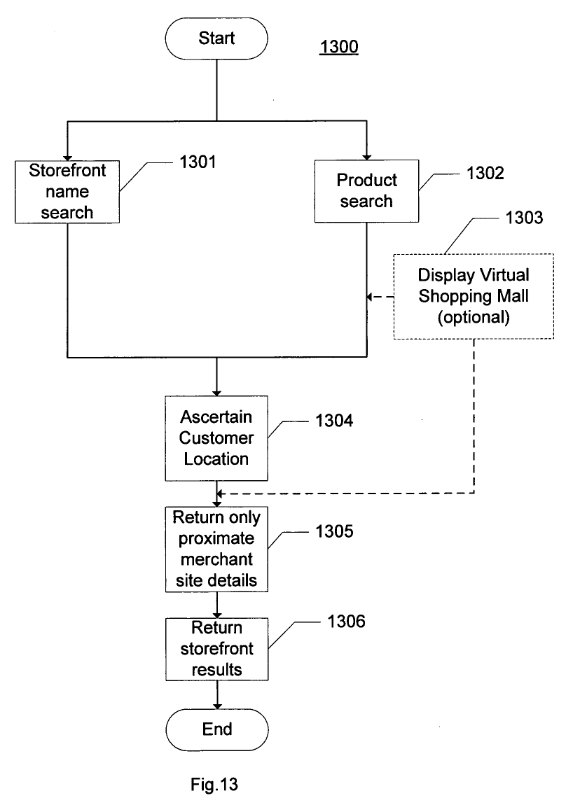

A method 1300 shown in FIG. 13 of searching for a merchant storefront on the website, according to one embodiment, will now be described. A user has a plurality of options for searching for a storefront.

In step 1301, being the storefront name search, the customer enters a storefront name search query.

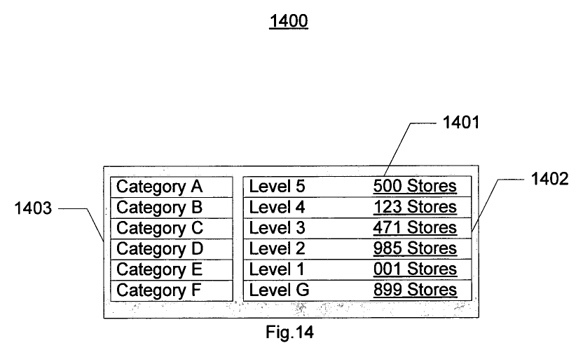

Alternatively, in step 1302, the user enters a product search query for all storefronts. In optional step 1303 a virtual mall is returned to visually represent and categorise the search results. A virtual shopping mall 1400 is shown in FIG. 14. The virtual shopping mall 1400 indicates the number of storefront matches 1401 on each level 1402 of the shopping mall. The levels group the goods or service by category 1403, for example “meat & deli” or “fruit & vegetable”.

When entering a search query, customers must additionally provide information about their geographical location. This can be, for example, a pick list of locales (e.g. suburbs or towns) or a postal/zip code. Alternatively, the geographical location is accessed from the customer profiles of customers who are currently logged onto the website. A customer creates a profile on the website by providing the required information for registration.

In step 1304, the server 102 uses the geographical location information to ascertain the customer's location. At this stage, the server 102 may also display the virtual shopping mall 1400. Also at this stage the server 102 may also return a web page relevant to the customer's location, for instance a page containing a plurality of advertising relevant to the customer's location.

The server 102 then, in step 1305, performs the search on the merchant web pages, and returns storefront results only for those merchants having a geographical location within the predefined proximity to the requesting customer.

The predefined proximity can be determined by various criteria, such as a distance radius. It is important that merchants who supply food product/s be proximate to customers, due to the perishable nature of these products. For this reason, the server 102 actively filters customer searches based on proximity. A typical distance is 75 km although in densely populated areas could be a shorter distance.

The storefronts that match the search query and fall within the predefined proximity are returned to the customer in step 1306. Preferably, the results are ranked by proximity distance in increasing order. The customer is then in a position to choose their storefront of preference by clicking on the storefront link.

The foregoing describes only some embodiments of the present invention, and modifications and/or changes can be made thereto without departing from the scope and spirit of the invention, the embodiments being illustrative and not restrictive.

1. A method of operating an online hosted customisable searchable merchant directory, said method comprising:
providing a plurality of storefront web page templates hosted on an Internet server;
receiving hosting requests from merchants, each request including an indication of the geographical location of said merchant;
providing access to said web page templates for merchants to modify said web page templates to represent a storefront associated with each merchant;
receiving a search query from a customer, said request including the customer's geographical location; and
returning only storefront results for merchants matching said search query and having a geographical location within a predetermined distance of said customer's location.

2. A method according to claim 1, wherein said customer search query contains required goods or services, and the results include only merchants having said goods or services.

3. A method according to claim 1, wherein said customer geographical location is defined by of the name of a locale or a postal code.

4. A method according to claim 1, further comprising providing a representation of a shopping mall to customers, where levels of said mall have grouped product types, and customers initiates a search for desired items located on the relevant level.

5. A method according to claim 1, wherein said products are food products.

6. A method according to claim 1, further comprising comparing the hosting request against a predetermined criterion to determine if the merchant is an acceptable merchant, and wherein said criterion includes any one of: a) that all required merchant information is included in said submitted data, b) that the hosting request includes a valid company registration indicator, or the merchant warrants that the company registration indicator is valid, or c) that the hosting request includes a certification that the merchant satisfies food safety standards, or the merchant warrants that it satisfied applicable the food safety standards.

7. A method according to claim 1, further comprising: maintaining a listing of customers that visited web pages of each merchant; and providing said listing to at least one merchant.

8. A method according to claim 1, further comprising providing merchants the ability to send electronic messages to customers who have subscribed to their mailing list.

9. An Internet server for operating an online hosted customisable searchable merchant directory comprising:
a data store configured to store a plurality of storefront web page templates;
a communication interface configured to i) receive a hosting request from a merchant, said data including a geographical location of said merchant, ii) provide access to said web page templates for merchants to modify said web page templates to represent a storefront associated with each merchant, and iii) receive a search query from a customer, said request including the geographical location of said customer; and
a processor configured to calculate the storefront results for merchants matching said search query and having a geographical location within a predetermined distance of said customer's locations,
wherein said communication interface is further configured to return said storefront results.

10. An Internet server according to claim 9, wherein said customer search query contains the required goods or services, and the results include only merchants having said goods or services.

11. An Internet server according to claim 9, wherein a data store containing customer geographical locations is defined by the name of a locale or a postal code.

12. An Internet Server according to claim 9, wherein said communication interface returns a representation of a shopping mall to customers, where levels of said mall have grouped product types, and customers initiates a search having items located on the relevant level.

13. An Internet server according to claim 9, wherein said products are food products.

14. An Internet server according to claim 9, wherein said processor compares a hosting request against a predetermined criterion to determine if the merchant is an acceptable merchant, and wherein said criterion includes at any of:
a) that all required merchant information is included in said hosting request,
b) that the hosting request includes a valid company registration indicator, or the merchant warrants that the company registration indicator is valid, or
c) that the hosting request includes a certification that the merchant satisfies food safety standards, or the merchant warrants that it satisfied applicable the food safety standards.

15. An Internet server according to claim 9, wherein said data store maintains a listing of customers that visited web pages of each merchant, and said communication interface for provides said listing to at least one merchant.

16. An Internet server according to claim 9, wherein said communication interface provides merchants the ability to send electronic messages to customers who have subscribed to their mailing list.

17. A system for operating a merchant directory comprising:
at least one merchant computer;
at least one customer computer; and
an Internet server, said server including:
a data store configured to store a plurality of storefront web page templates;
a communication interface configured to i) receive a hosting request from a merchant computer, said data including a geographical location of said merchant, ii) provide access to said web page templates for merchants to modify said web page templates to represent a storefront associated with each merchant, and iii) receive a search query from a customer computer, said request including the geographical location of the customer; and
a processor configured to calculate the storefront results for merchants matching said search query and having a geographical location within a predetermined distance of said customer's location,
wherein the communication interface is further configured to return said storefront results.

18. A system for operating an online hosted customisable searchable merchant directory, said system comprising:
means for providing a plurality of storefront web page templates hosted on an Internet server;
means for receiving hosting requests from merchants, each request including an indication of the geographical location of said merchant;
means for providing access to said web page templates for merchants to modify said web page templates to represent a storefront associated with each merchant;
means for receiving a search query from a customer, said request including the customer's geographical location; and
means for returning only storefront results for merchants matching said search query and having a geographical location within a predetermined distance of said customer's location.
